(19) United States
(12) Patent Application Publication
(10) Pub. No.: US 2014/0174895 A1
(43) Pub. Date: Jun. 26, 2014

(54) CONTACT ARRANGEMENT FOR HIGH VOLTAGE SWITCHGEAR WITH CONTACT ARRANGEMENT

(71) Applicant: ABB TECHNOLOGY AG, Zurich (CH)

(72) Inventors: Helmut HEIERMEIER, Wutoschingen (DE); Carl KURINKO, North Huntingdon, PA (US); Florian BRANDL, Zurich (CH); Juerg BRYNER, Zurich (CH)

(73) Assignee: ABB Technology AG, Zurich (CH)

(21) Appl. No.: 13/722,114

(22) Filed: Dec. 20, 2012

(51) Int. Cl. H01H 1/00

(52) U.S. Cl. CPC H01H 1/00
USPC 200/275; 439/884

(57) ABSTRACT

A contact arrangement has a symmetry axis (z) and includes at least a first elongated contact and at least a second elongated contact. At least one of the contacts is movable linearly along the axis (z) relative to the other contact and contacts it electrically and mechanically at a front face of each contact. The first and/or the second contact is at least partially hollow, thereby forming a hollow space in its interior. A diameter, with regard to the axis (z), of the hollow space of the first and/or the second contact varies along at least a section of the hollow space and the hollow space has an opening on the front face of the first and/or the second contact.

### TECHNICAL FIELD

The invention relates to the field of medium and high voltage switching technologies and concerns a contact arrangement and an electrical switching device according to the independent claims, particularly for a use in or as an earthing device, a fast-acting earthing device, a circuit breaker, a generator circuit breaker, a switch disconnector, a combined disconnector and earthing switch, a closing resistor contact arrangement or a load break switch in power transmission and distribution systems.

### BACKGROUND

Electrical switching devices are well known in the field of medium and high voltage switching applications. They are e.g. used for interrupting a current when an electrical fault occurs. As an example for an electrical switching device, circuit breakers have the task of opening contacts and keeping them far apart from one another in order to avoid a current flow, even in case of high electrical potential originating from the electrical fault itself. Another device of this type is a fast acting earthing device or closing resistor switch. The main aim of such devices is to close into a fault or a precharged line to connect different networks or ground. For the purposes of this disclosure the term medium voltage refers to voltages from 1 kV to 72.5 kV and the term high voltage refers to voltages higher than 72.5 kV. Typically, such earthing devices have two contacts which are located in an atmosphere of an insulating gas, e.g. SF6 or air or other dielectric insulation media or gas mixtures, such as gas mixtures comprising a fluoroketone. In embodiments the contacts are rod-type contacts which are moved along at least an axis of the electrical switching device.

During the closing process of the electrical switching device an undesired electric arc forms between the contacts. Due to thermal and magnetic effects (depending on a current path and the construction of the electrical switching device) the arc tends to form in areas where it is not allowed, e.g. in the area of shieldings. As such devices are often used in failure cases (e.g. in case of overload due to short circuits) the closing speed of the contacts has to be relatively high in order for the devices to be highly responsive. When the contacts are moved towards one another, the insulating gas which is present in the areas between the contacts is compressed. This is typically the case for solid contacts which do not penetrate one another. It has been observed that this pressure build-up causes the electric arc to be “pushed” to the outside of the contacts (with respect to the axis of the switching device). This behaviour has to be avoided in order to prevent the arc from leaving footprints on other elements of the electrical switching device (e.g. on said shieldings), which would otherwise cause damages to said elements.

### DESCRIPTION OF THE INVENTION

It is an objective of the present invention to improve a contact arrangement of an electrical switching device with respect to the path of the arc between the contacts when the switching device is being closed.

The objective is solved by the subject-matter of the independent claims. Embodiments are given in the dependent claims and their combinations.

In one aspect of the invention, the contact arrangement has at least an axis, in particular symmetry axis, and comprises at least a first elongated contact and at least a second elongated contact. At least one of the first and second contact is movable, for example is movable linearly along the axis or along a curvature, relatively to the other contact and is designed for contacting it electrically and mechanically. The electrical and mechanical contact occurs at a front face of each contact. The first and/or the second contact is at least partially hollow, thereby forming a hollow space in its interior. A diameter (with regard to the axis) of the hollow space of the first and/or the second contact varies along at least a section of the hollow space. The hollow space has an opening on the front face of the first and/or the second contact.

In embodiments, the hollow space (6a, 6b) has an extension along an axis, and the axis of the hollow space is a symmetry axis of the hollow space, and/or the axis of the hollow space is parallel to or identical with the axis z of the contact arrangement.

Furthermore, the invention concerns an electrical switching device comprising such a contact arrangement.

By providing a hollow space in the first contact and/or in the second contact, having an opening to the exterior of the contact or contacts, a new evacuation path for the fluid (insulating gas) located between the first and the second contact is created. In this case, when the contacts are closed, the fluid escapes from the area between the first and the second contact not only to the sides of the contacts but also into the hollow space. This measure avoids the building of overpressure between the contacts. Consequently, the electric arc building up before the first and the second contact touch is kept substantially “in the middle” (close to the longitudinal axis) of the contacts and is not pushed to their extremities. Thus, the danger of the arc leaving footprints on other elements of the contact arrangement is minimized. By designing the hollow space to have varying diameters it is possible to optimize the fluid flow through the hollow space during the closing process of the contacts in terms of evacuation speed.

Such an improvement results in several important benefits for an electrical switching device, e.g. a resistor switch comprising a contact arrangement according to the invention, by preventing damage to the shieldings of the contacts and thus prolonging the life of the electrical switching device.

The first and the second contact according to the invention may e.g. be the contacts of a fast acting earthing device or they may be arcing contacts in other switching devices. However, the concept of the invention may be applied to any kind of contacts, in particular of electrical switching devices of the type mentioned above in case of which electric arcs are generated between two contacts in an insulating gas atmosphere.

In embodiments the first contact is a moving contact and the second contact is a fixed contact.

In other embodiments the first contact and the second contact are moving contacts.

Advantageously, the hollow space of the first and/or the second contact has a nozzle-shaped first section starting at the opening. The advantage of forming the first section in the shape of a nozzle is that the fluid velocity through the first section is increased. Thus, the fluid can be evacuated faster from the area between the contacts.

In a preferred embodiment the first section has the shape of a de-Laval-nozzle, thus being formed substantially as e.g. an hourglass. This particular shape further increases the acceleration of the fluid through the first section of the hollow space.

Advantageously, the hollow space has a second section in fluid-connection with, in particular following downstream, the nozzle-shaped section, a volume of which is at least 3-times larger than a volume of the first section. By this it is made sure that the space into which the accelerated fluid escapes from the area between the contacts via the first section of the hollow space is large enough for a quick evacuation of the fluid.

In embodiments an additional rod-shaped or tube-shaped contact is provided at least partially inside the first section of the hollow space of the first and/or the second contact. The additional contact is for attracting an electrical arc. The additional contact can electrically be connected to the first contact, when it is provided in the hollow space of the first contact, and/or the additional contact can electrically be connected to the second contact, when it is provided in the hollow space of the second contact. Furthermore, the additional contact can be arranged substantially concentrically to and at least partially inside the first section of its respective first or second contact. The additional contact or contacts further contributes or contribute to keep the arc from being pushed to the sides, i.e. radially outwards, of the contacts. This will be explained in more detail in connection with an exemplary embodiment of the invention.

Advantageously, the at least one additional contact protrudes out of the hollow space, in particular out of the first section or mouth section of the hollow space, and beyond the opening of the hollow space of the first and/or the second contact by not more than 10 millimeters. By arranging the at least one additional contact or contacts to protrude beyond the opening of its first and/or the second contact, respectively, the distance between the first and the second contact is decreased, such that the arc initially forms between the additional contacts when closing the contact arrangement and is thereby prevented from drifting laterally, i.e. to the sides of the first and/or the second contact, respectively. In an opened configuration of the contact arrangement there has to be a certain distance between the first and the second contact such that no discharges can occur in this opened state of the contacts. This is particularly important in case of very high voltage devices. By limiting the protrusion of the additional contact or contacts it is made sure that said required minimum distance between the first and the second contact in an opened configuration of the contact arrangement is respected.

In one embodiment the at least one additional contact is reversibly pushable into the hollow space, in particular by at least 5 millimeters. Advantageously, the at least one additional contact is reversibly pushable into the hollow space against a spring force generated by at least one spring, in particular by at least one spring being arranged inside the hollow space of the first and/or the second contact and acting on the additional contact. By designing the additional contact or contacts to be pushable into the hollow space it is made sure that the front faces of the first and the second contact are able to touch when the contacts are closed. Using a spring for providing a certain mobility of the additional contact or contacts is a simple and cost-effective solution to provide the mobility of the additional contact or contacts. For example, considering a configuration with a movable first contact and a fixed second contact, wherein the movable first contact has a hollow space equipped with an additional contact, the additional contact is pushed inside the hollow space by the front face of the second contact until the first and the second contact touch one another, when the contact arrangement is closed. In another example, considering a configuration with the first and the second contact having both a hollow space and each hollow space being equipped with its respective additional contact, the front faces of the additional contacts meet and the additional contacts push one another back into their respective hollow space.

The electrical switching device with a contact arrangement according to the invention may be used e.g. as an earthing device, a fast-acting earthing device, a circuit breaker, a generator circuit breaker, a switch disconnector, a combined disconnector and earthing switch, or a load break switch.

### SHORT DESCRIPTION OF THE DRAWINGS

Embodiments, advantages and applications of the invention result from the dependent claims and from the now following description by means of the figures. It is shown in:

FIG. 1 a schematized sectional view of a basic embodiment of a fast acting earthing device;

FIG. 2 a sectional view of a first embodiment of a contact arrangement according to the invention; and

FIG. 3 a sectional view of a second embodiment of a contact arrangement according to the invention.

### WAYS OF CARRYING OUT THE INVENTION

The invention is described for the example of a fast acting earthing device, but the principles described in the following also apply for the usage of the invention in other switching devices, e.g. of the type mentioned at the beginning.

In the following same reference numerals denote structurally or functionally same or similar elements of the various embodiments of the invention.

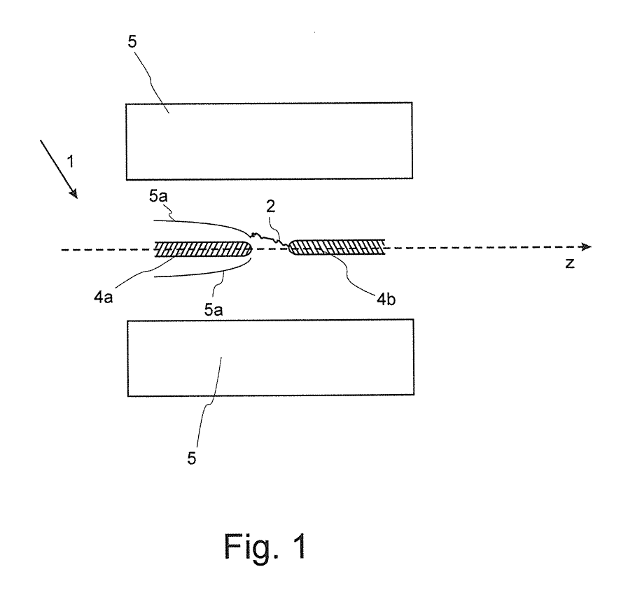

FIG. 1 shows a simplified schematized sectional view of a basic embodiment of a fast acting earthing device 1 in an opened configuration. Such earthing devices 1 are known by the skilled person in high voltage electrical engineering and will therefore not be described here in more detail.

A “closed configuration” as used herein means that the nominal contacts and/or the arcing contacts of the circuit breaker are closed. Accordingly, an “opened configuration” as used herein means that the nominal contacts and/or the arcing contacts of the circuit breaker are opened. In particular, “opened configuration” and “closed configuration” relate to end positions of the nominal contacts and/or arcing contacts.

In the present example of the fast acting earthing device it is assumed that the earthing device is rotationally symmetric with respect to a longitudinal axis z and that the contacts of the earthing device 1 move parallel to the longitudinal axis z for closing and opening. However it is possible that at least one of the contacts moves along a more complex path than a linear path. For example it may move along a curve or curvature or it may perform a combined translation and rotation movement. Thus, in the following example any reference to the longitudinal axis in the context of elements or shapes of the invention typically reflects a symmetry axis of that element, regardless of its location during the closing or opening process.

The earthing device 1 is enclosed by a shell which in this example may be cylindrical and is arranged around the longitudinal axis z. It comprises a contact arrangement formed by a first and a second solid, rod-type contact 4a, 4b. A shielding 5a is arranged around the first contact 4a.

In this example it is assumed that the first contact 4a is movable relatively to the second contact 4b from said closed configuration, in which the contacts 4a, 4b are in electrical contact to one another, into the opened configuration shown in FIG. 1, in which they are apart from one another, and vice versa. Furthermore it is assumed that the second contact 4b is fixed. As mentioned, it is possible that both contacts 4a, 4b are movable parallel to the longitudinal axis z towards one another or apart from one another. It is further assumed that the earthing device 1 is in the process of being closed, wherein FIG. 1 shows the undesired effect described above. The electric arc 2, which ideally should run on the longitudinal axis z between the first and the second contact 4a, 4b, burns between the contacts 4b and the shielding 5a. For the purpose of this disclosure the area around the electric arc 3 is called heating-up area or arcing zone.

For the purposes of this disclosure the fluid used in the electrical switching device or circuit breaker comprising the contact arrangement can be SF6 gas or any other dielectric insulation medium, may it be gaseous and/or liquid, and in particular can be a dielectric insulation gas or arc quenching gas. Such dielectric insulation medium can for example encompass media comprising an organofluorine compound, such organofluorine compounds being selected from the group consisting of: a fluoroether, a fluoroamine, a fluoroketone, an oxirane, a hydrofluorolefin, and mixtures thereof; and preferably being a fluoroketone and/or a fluoroether, more preferably a perfluoroketone and/or a hydrofluoroether. Herein, the terms “fluoroether”, “fluoroamine” and “fluoroketone” refer to at least partially fluorinated compounds. In particular, the term “fluoroether” encompasses both hydrofluoroethers and perfluoroethers, the term “fluoroamine” encompasses both hydrofluoroamines and perfluoroamines, and the term “fluoroketone” encompasses both hydrofluoroketones and perfluoroketones. It can thereby be preferred that the fluoroether, the fluoroamine, the fluoroketone and the oxirane are fully fluorinated, i.e. perfluorinated.

In particular, the term “fluoroketone” as used in the context of the present invention shall be interpreted broadly and shall encompass both fluoromonoketones and fluorodiketones or generally fluoropolyketones. The term shall also encompass both saturated compounds and unsaturated compounds including double and/or triple bonds between carbon atoms. The at least partially fluorinated alkyl chain of the fluoroketones can be linear or branched and can optionally form a ring.

In particular, the fluoroketone can be a fluoromonoketone and/or may also comprise heteroatoms, such as at least one of a nitrogen atom, oxygen atom and sulphur atom, replacing one or more carbon atoms. More preferably, the fluoromonoketone, in particular perfluoroketone, shall have from 3 to 15 or from 4 to 12 carbon atoms and particularly from 5 to 9 carbon atoms. Most preferably, it may comprise exactly 5 carbon atoms and/or exactly 6 carbon atoms and/or exactly 7 carbon atoms and/or exactly 8 carbon atoms.

The dielectric insulation medium can further comprise a background gas or carrier gas different from the organofluorine compound, in particular different from the fluoroether, the fluoroamine, the fluoroketone, the oxirane and the hydrofluorolefin and preferably can be selected from the group consisting of: air, N2, O2, CO2, a noble gas, H₂; NO₂, NO, N₂O, fluorocarbons and in particular perfluorocarbons and preferably CF₄, CF₃I, SF₆, and mixtures thereof.

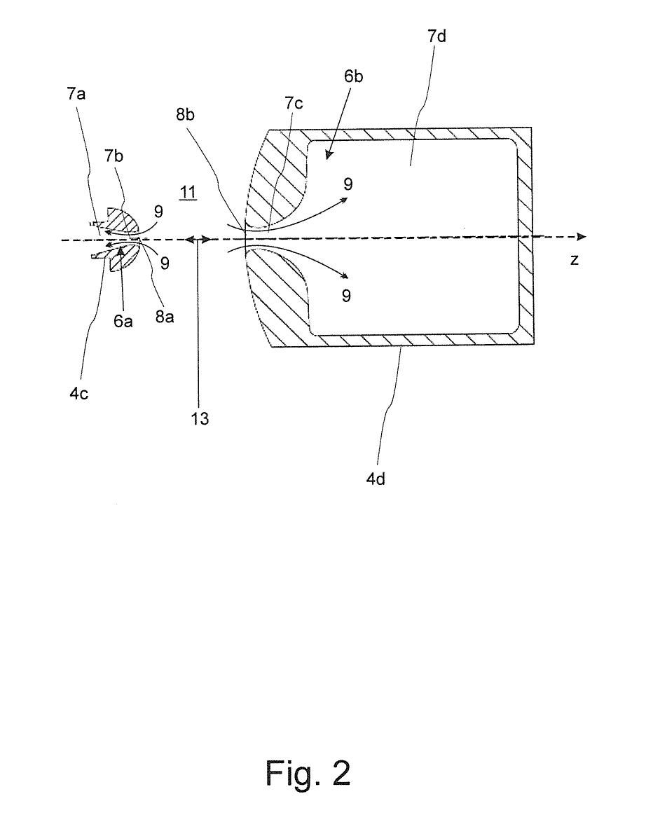

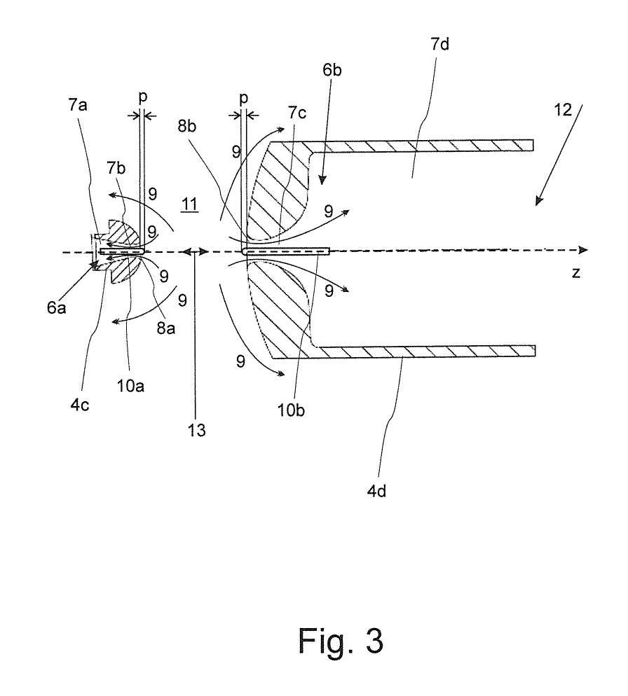

FIG. 2 shows a sectional view of a first embodiment of a contact arrangement according to the invention. For reasons of simplicity only the first and the second contact 4c, 4d according to embodiments of the invention are shown in FIGS. 2 and 3. The contacts 4c, 4d according to the invention replace the first and the second contact 4a, 4b of FIG. 1. For closing the contact arrangement the first contact 4c is moved in the direction of the arrow z towards the second contact 4d. The two contacts are making contact with their front faces 13. The two contacts 4c, 4d are hollow and enclose each a hollow space 6a, 6b, respectively. The hollow spaces 6a, 6b have each an entrance opening 8a, 8b, respectively, through which a fluid 11 (insulating gas) can enter the respective hollow space 6a, 6b. The hollow spaces 6a, 6b of the first and the second contact 4c, 4d, respectively, comprise each a first section or mouth section 7b, 7c, respectively, and a second section or throat section 7a, 7d, respectively, following downstream the first section 7b, 7c. A second opening 12 is provided for example downstream or at one end of the second section 7a, here exemplarily the second section 7a of the first contact 4a. The flow directions of the fluid 11 during the closure of the contacts 4c, 4d are schematically illustrated by double arrows 9.

FIG. 3 shows a sectional view of a second embodiment of a contact arrangement according to the invention. The second embodiment is similar to the first embodiment and differs from it on the one hand by the provision of additional contacts 10a, 10b for at least one and here of each contact 4c, 4c, respectively, and on the other hand by the provision of the second opening or exit opening 12 of the second section 7d of the second contact 4b. It is understood that both contacts 4c, 4d may have a second opening 12 or they may have no second opening 12. The second opening has the advantage that the fluid 11 located inside the hollow spaces 6a, 6b may escape to the exterior of the contacts 4c, 4d, thus avoiding overpressure in their interior. The additional contacts 10a, 10b are rod-shaped and protrude out of the hollow space (6a, 6b) and beyond the entrance openings 8a, 8b. They are reversibly pushable into the respective hollow space 6a, 6b by at least the length of the protrusion p. The term “reversibly” means in the context of this disclosure that the additional contact can also be pushed back into the position where it protrudes again beyond the respective opening 8a, 8b. Several means for actuating the additional contact or contacts 10a, 10b may be used, of which a spring (not shown) is preferred because of its simplicity.

As mentioned, when the first contact 4a is moved towards the second contact 4b, the fluid 11 located between the two contacts 4a, 4b is compressed and escapes laterally, i.e. to the sides, of the contacts 4a, 4b and through the hollow spaces 6a, 6b in the directions of the arrows 9.

As can be seen from FIGS. 2 and 3, the first sections 7b, 7c of the hollow spaces 6a, 6b are formed as a nozzle and substantially as a de-Laval-nozzle, thus having the shape similar to an asymmetric hourglass. This nozzle shape is particularly suitable to accelerate the hot, pressurized fluid 11 passing through it to a supersonic speed and, upon expansion into the volume bordering the second section 7a, 7d, to shape the exhaust flow so that the heat energy propelling the flow is maximally converted into directed kinetic energy.

By modifying rod-shaped contacts in the way proposed by the invention it is possible to prevent the arc generated when the contacts are closed from drifting to areas where it may cause damage to the circuit breaker or electrical switching device in general. Depending on the type of circuit breaker, the one or the other embodiment may be chosen. The higher the closing speed of the contacts is, the more the insulating gas 11 is compressed and the drifting of the arc is more pronounced. In such cases the embodiment of FIG. 3 may be advantageous because of the optional measure of keeping the arc “in the middle” by the additional contacts.

While there are shown and described presently preferred embodiments of the invention, it is to be distinctly understood that the invention is not limited thereto but may otherwise variously be embodied and practised within the scope of the following claims. Therefore, terms like “preferred” or “in particular” or “particularly” or “advantageously”, etc. signify optional and exemplary embodiments only.

### List of Reference Numerals

1=basic circuit breaker
2=electric arc
3a=first nominal contact
3b=second nominal contact
4a=first contact according to the prior art
4b=second contact according to the prior art
4c=first contact according to the invention
4d=second contact according to the invention
5 =shell
5a=shielding
6a=hollow space of first contact
6b=hollow space of second contact
7a=second section of first contact
7b=first section of first contact
7c=second section of second contact
7d=first section of second contact
8a=opening of first contact, entrance opening
8b=opening of second contact, entrance opening
9=flow of the fluid during contact closure
10a=first additional contact
10b=second additional section
11=fluid
12=second opening, exit opening
13 =front face of the contacts
p=protrusion
z=longitudinal axis

1. Contact arrangement having at least an axis (z), and comprising:
at least a first elongated contact and at least a second elongated contact, wherein at least one of the first and second contacts is movable relative to the other contact and is designed for contacting the other contact electrically and mechanically, at a front face of each of the first and second contacts;
wherein the first contact and/or the second contact is at least partially hollow, thereby forming a hollow space in its interior, wherein a diameter, with regard to the axis (z), of the hollow space of the first contact and/or the second contact varies along at least a section of the hollow space, and the hollow space has an opening on the front face of the first contact and/or the second contact.

2. Contact arrangement according to claim 1, wherein the first contact is a movable contact and the second contact is a fixed contact.

3. Contact arrangement according to claim 1, wherein the first contact and the second contact are movable contacts.

4. Contact arrangement device according to claim 1, wherein the hollow space of the first contact and/or the second contact has a nozzle-shaped first section starting at the opening.

5. Contact arrangement according to claim 4, wherein the hollow space has a second section being in fluid-connection with the first section, a volume of which is at least 3-times larger than a volume of the first section.

6. Contact arrangement according to claim 4, comprising:
an additional contact which is a rod-shaped or tube-shaped contact and which is provided at least partially inside the hollow space of the first contact and/or the second contact.

7. Contact arrangement according to claim 6, wherein the additional contact, when arranged at the first contact, is electrically connected to the first contact, and/or wherein the additional contact, when arranged at the second contact, is electrically connected to the second contact.

8. Contact arrangement according to claim 6, wherein the at least one additional contact is arranged substantially concentrically to and at least partially inside the first section of the hollow space of the first contact and/or of the second contact.

9. Contact arrangement according to claim 6, wherein the at least one additional contact protrudes out of the hollow space and beyond the opening of the hollow space of the first contact and/or the second contact by not more than 10 millimeters.

10. Contact arrangement according to claim 6, wherein the at least one additional contact is reversibly pushable into the hollow space.

11. Contact arrangement according to claim 6, wherein the at least one additional contact is reversibly pushable into the hollow space against a spring force generated by at least one spring.

12. Contact arrangement according to claim 5, wherein a section of the hollow space has a second opening.

13. Contact arrangement according to claim 1, wherein the at least one axis (z) of the contact arrangement is at least one symmetry axis (z) of the contact arrangement, and/or wherein the at least one of the first and second contacts is movable linearly along the axis or is movable along a curvature.

14. Contact arrangement according to claim 1, wherein the hollow space has an extension along an axis, and the axis of the hollow space is a symmetry axis of the hollow space and/or the axis of the hollow space is parallel to or identical with the axis (z) of the contact arrangement.

15. Electrical switching device comprising:
a switch in combination with a contact arrangement according to claim 1.

16. Electrical switching device according to claim 15, comprising:
a dielectric insulation medium that comprises an organofluorine compound selected from the group consisting of: a fluoroether, a fluoroamine, a fluoroketone, and mixtures thereof, in particular in a mixtures with a background gas.

17. Electrical switching device according to claim 15, in combination with a device sleeted from the group consisting of:
an earthing device, a fast-acting earthing device, a circuit breaker, a generator circuit breaker, a switch disconnector, a combined disconnector and earthing switch, a closing resistor contact arrangement or a load break switch.
